(19) United States
(12) Patent Application Publication
(10) Pub. No.: US 2008/0079315 A1
(43) Pub. Date: Apr. 3, 2008

(54) Semiconductor integrated circuit and multi-output power supply apparatus using the same

(75) Inventors: Mikio Motomori, Osaka (JP); Takuya Ishii, Osaka (JP); Yoichi Deguchi, Osaka (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 11/905,052

(22) Filed: Sep. 27, 2007

(30) Foreign Application Priority Data
Sep. 29, 2006 (JP) 2006-266151

(51) Int. Cl. H02J 1/10

(52) U.S. Cl. 307/43

(57) ABSTRACT

A semiconductor integrated circuit (10A) which converts an input supply voltage (Vi=2.5 to 4 V) applied to an input terminal (P1) into a first output voltage (Vo1=5 V) and outputs the first output voltage from an output terminal (P2), includes a first control circuit (17) which supplies a switching unit (11, 12, 13, 14) interposed between the input terminal (P1) and the output terminal (P2) with a switching signal so as to bring a feedback voltage (Vf1) based on an output voltage of the output terminal (P2) close to a target value; and an external setting terminal (P3) which sets the feedback voltage (Vf1) to a prescribed potential regardless of voltage of the output terminal (P2).

### FIELD OF THE INVENTION

The present invention relates to a multi-output power supply apparatus which generates multiple output voltages.

### BACKGROUND OF THE INVENTION

Electronic equipment such as portable equipment operates on a battery and is equipped with a multi-output power supply apparatus made up of multiple power supply circuits to convert a battery voltage into a desired supply voltage for any of various electronic circuits in the equipment.

The battery voltage which serves as an input voltage to the multi-output power supply apparatus is, for example, 2.5 to 4 V if a single-cell lithium-ion battery is used. On the other hand, there is demand for a wide variety of supply voltages. For example, voltages used for digital still cameras include a 5-V voltage for lens driving and 12-V or 6-V voltage for CCD biasing.

FIG. 4 shows a circuit block diagram of a conventional multi-output power supply apparatus designed based on power supply specifications such as described above.

In FIG. 4, reference numeral 1 denotes an input power supply which supplies an input voltage Vi, where Vi=2.5 to 4 V in the case of a single-cell lithium-ion battery. Reference numeral 10 denotes a boost converter which serves as a first power supply circuit. The boost converter 10 includes an inductor 11 and main switch 12 connected in series with each other and in parallel to the input power supply 1, a diode 13 connected to a junction point of the main switch 12 and inductor 11, an output capacitor 14 which, being connected to an output of the diode 13, outputs a first output voltage Vo1 (e.g., 5 V), a resistor 15 and resistor 16 which produce a fraction of the first output voltage Vo1 as a feedback voltage Vf1, and a first control circuit 17 which turns on and off the main switch 12.

The first control circuit 17 has a control terminal 17a, feedback terminal 17b, and pulse output terminal 17c. It starts operation when a first control signal Vc1 applied to the control terminal 17a is High. The first control circuit 17 outputs, from the pulse output terminal 17c, a pulse signal Vg1 whose on-off time ratio has been adjusted so that the feedback voltage Vf1 inputted in the feedback terminal 17b will be equal to a predetermined reference voltage Vr.

Reference numeral 20 denotes a boost converter which serves as a second power supply circuit. The boost converter 20 includes an inductor 21 and main switch 22 connected in series with each other and in parallel to the output capacitor 14 of the first power supply circuit 10, a diode 23 connected to a junction point of the main switch 22 and inductor 21, an output capacitor 24 which, being connected to an output of the diode 23, outputs a second output voltage Vo2 (e.g., 12 V), a resistor 25 and resistor 26 which produce a fraction of the second output voltage Vo2 as a feedback voltage Vf2, and a second control circuit 27 which turns on and off the main switch 22.

The second control circuit 27 has a control terminal 27a, feedback terminal 27b, and pulse output terminal 27c. It starts operation when a High signal is applied to the control terminal 27a. The second control circuit 27 outputs, from the pulse output terminal 27c, a pulse signal Vg2 whose on-off time ratio has been adjusted so that the feedback voltage Vf2 inputted in the feedback terminal 27b will be equal to the predetermined reference voltage Vr.

Reference numeral 28 denotes an AND circuit which outputs a second signal V2 which is a logical product of a power-on signal Von and second control signal Vc2 (described later) to the control terminal 27a.

Reference numeral 30 denotes a power-on signal generating circuit which includes a comparison circuit 31 and AND circuit 32, where the comparison circuit 31 serves as a first comparison circuit which outputs a High signal when the first output voltage Vo1 is equal to or larger than a predetermined value (e.g., 90% of a target voltage) and the AND circuit 32 outputs the power-on signal Von which is a logical product of an output of the comparison circuit 31 and the first control signal Vc1.

Now, operation of the first power supply circuit 10 will be described.

When the first control signal Vc1 goes High, the first control circuit 17 starts operation. Subsequently, when the main switch 12 turns on in response to the pulse signal Vg1 outputted from the pulse output terminal 17c, the input voltage Vi is applied to the inductor 11, energizing the inductor 11 and passing a current through the inductor 11.

Next, when the main switch 12 turns off, a decreasing current flows through the output capacitor 14 via the inductor 11 and diode 13. Through repetition of the on/off operation, power is supplied from the input power supply 1 and the first output voltage Vo1 is outputted from the output capacitor 14.

The first output voltage Vo1 is controlled by an on-off time ratio of the main switch 12 and the first control circuit 17 controls the on-off time ratio of the pulse signal Vg1 so that the feedback voltage Vf1 will be equal to the predetermined reference voltage Vr. Consequently, the first output voltage Vo1 is stabilized at a target value.

Next, if the first output voltage Vo1 is equal to or larger than the predetermined value, the comparison circuit 31 of the power-on signal generating circuit 30 outputs a High. The AND circuit 32 outputs a logical product of the comparison circuit's (31) output, second control signal Vc2, and first control signal Vc1 which is already High, and the power-on signal Von outputted from the AND circuit 32 goes High when the second control signal Vc2 becomes High.

In the second power supply circuit 20, the second control circuit 27 starts operation when the power-on signal Von in a High state is inputted in the control terminal 27a, and turns on and off the main switch 22 according to the pulse signal Vg2 from the pulse output terminal 27c. Subsequent operation of the second power supply circuit 20 is the same as the first power supply circuit 10. Specifically, by turning on and off the main switch 22, the second power supply circuit 20 boosts the first output voltage Vo1 to the second output voltage Vo2 and stabilizes the second output voltage Vo2 at a target value.

A multi-output power supply apparatus often starts up various supply voltages in a time-staggered manner to disperse a rush current on start-up or at the request of various electronic circuits (hereinafter referred to as a load side) supplied with the supply voltages. According to basic specifications, the multi-output power supply apparatus in FIG. 4 starts the first output voltage Vo1 in response to the first control signal Vc1 and starts the second output voltage Vo2 in response to the second control signal Vc2.

However, since the first output voltage Vo1 is used as an input to the second power supply circuit 20, the second power supply circuit 20 cannot operate unless the first power supply circuit 10 is operating and the first output voltage Vo1 has started completely. Thus, the second signal V2 inputted in the control terminal 27a on the second control circuit 27 of the second power supply circuit 20 is the logical product of the power-on signal Von and the second control signal Vc2.

As an input power supply, instead of using a single-cell lithium-ion battery such as described above, some electronic equipment uses, for example, an AC adaptor which outputs 4.5 to 5.5 VDC or a step-down power supply apparatus which draws power from a two-cell lithium-ion battery and outputs 5 V. If it is desired to use the multi-output power supply apparatus as well for such electronic equipment, the first power supply circuit 10 based on different input specifications cannot support such electronic equipment.

To make the multi-output power supply apparatus in FIG. 4 compatible with such input specifications, a method disclosed in Japanese Patent Laid-Open No. 5-184136, for example, is available.

Although the method disclosed in Japanese Patent Laid-Open No. 5-184136 does not concern a multi-output power supply apparatus, it involves installing a switch unit to switch between output via a power supply apparatus and direct output of an input voltage depending on the input voltage in order to support various input voltages. Although not illustrated, if the method disclosed in Japanese Patent Laid-Open No. 5-184136 is applied to the multi-output power supply apparatus in FIG. 4, when an output from an external power supply apparatus such as an AC adaptor is received as an input, the newly installed switch unit deactivates the first power supply circuit 10 to use the output of the external power supply apparatus as the first output voltage Vo1 instead.

### DISCLOSURE OF THE INVENTION

The conventional multi-output power supply apparatus described above cannot accommodate situations in which an AC adaptor or other power supply apparatus of different input specifications is used as an input power supply. The following problems are encountered when using an output from an AC adaptor or other external power supply apparatus as the first output voltage by referring to the method disclosed in Japanese Patent Laid-Open No. 5-184136.

When the first power supply circuit 10 is in condition to operate, a feedback voltage to the feedback terminal 17b of the first control circuit 17 can cause the main switch 12 to turn on and off, resulting in a waste of electric power. To deactivate the first power supply circuit 10, the first control signal Vc1 can be set Low. However, this causes the power-on signal Von to become Low, making it impossible for the second power supply circuit 20 to operate.

In other words, when a predetermined battery is used as an input power supply, the second power supply circuit 20, which operates on conditions that the first power supply circuit 10 operates and that the first output voltage Vo1 is supplied in a stable manner, cannot operate when the first power supply circuit 10 is deactivated to reduce power consumption or the like in a configuration in which the output from an external power supply apparatus is used as the first output voltage Vo1.

An object of the present invention is to provide a semiconductor integrated circuit which can be used as a first power supply circuit 10 when a predetermined battery is used as an input power supply and reduce power consumption even when an output from an external power supply apparatus is used as a first output voltage Vo1. Another object of the present invention is to provide a multi-output power supply apparatus which uses the semiconductor integrated circuit.

The present invention provides a semiconductor integrated circuit which converts an input supply voltage applied to an input terminal into a first output voltage and outputs the first output voltage from an output terminal, including: a first control circuit which supplies a switching unit interposed between the input terminal and the output terminal with a switching signal so as to bring a feedback voltage based on an output voltage of the output terminal close to a target value; and an external setting terminal which sets the feedback voltage to a prescribed potential regardless of voltage of the output terminal.

The present invention provides a multi-output power supply apparatus including: a first power supply circuit made up of a semiconductor integrated circuit which converts an input supply voltage applied to an input terminal into a first output voltage and outputs the first output voltage from a first output terminal; and a second power supply circuit which converts the first output voltage outputted from the first output terminal of the first power supply circuit into a second output voltage and outputs the second output voltage from a second output terminal, wherein the first power supply circuit has a first control circuit which supplies a switching unit interposed between the input terminal and the first output terminal with a switching signal so as to bring a feedback voltage based on an output voltage of the first output terminal close to a target value, an external setting terminal which sets the feedback voltage to a prescribed potential regardless of voltage of the output terminal, and a power-on signal generating circuit which generates a power-on signal using a logical product of a detection signal which indicates that the first output voltage is equal to or higher than a predetermined output voltage value and a detection signal which indicates that the feedback voltage is equal to or lower than a prescribed potential; the second power supply circuit operates in response to the power-on signal generated from the first power supply circuit; and the first control circuit of the first power supply circuit stops supplying the switching signal when the external setting terminal is set to a lower potential limit.

Furthermore, the power-on signal generating circuit includes a first comparison circuit which detects that the feedback voltage is equal to or higher than the predetermined output voltage value, a second comparison circuit which detects that the feedback voltage is equal to or lower than the prescribed potential, and an AND circuit which generates the power-on signal using a logical product of a detection signal on an output side of the first comparison circuit and a detection signal on an output side of the second comparison circuit.

Furthermore, the second power supply circuit includes a second control circuit which supplies a second switching unit interposed between the first output terminal and the second output terminal with a switching signal so as to bring a feedback voltage based on an output voltage of the second output terminal close to a target value; and the second power supply circuit controls supply of the power-on signal from the power-on signal generating circuit to the second control circuit based on a result of a logical operation with a second control signal which externally instructs the second power supply circuit to start or stop operation.

Furthermore, the power-on signal generating circuit is equipped with a first comparison circuit which compares the first output voltage or a fraction of the first output voltage with a fraction of the predetermined reference voltage and thereby determines whether the first output voltage is equal to or higher than the predetermined output voltage value.

Furthermore, the power-on signal generating circuit is equipped with a second comparison circuit which compares a voltage of the feedback with a predetermined lower limit and produces an output so that the voltage of the feedback will be equal to or higher than the predetermined lower limit during a predetermined period of start-up upon application of an input voltage or upon input of a first control signal.

The present invention provides a semiconductor integrated circuit used for a multi-output power supply apparatus that includes a first power supply circuit which converts an input supply voltage applied to an input terminal into a first output voltage and outputs the first output voltage from an output terminal, and a second power supply circuit which converts the first output voltage outputted from the first output terminal of the first power supply circuit into a second output voltage and outputs the second output voltage from a second output terminal, the semiconductor integrated circuit including: a first control circuit which supplies a switching unit interposed between the input terminal and the output terminal with a switching signal so as to bring a feedback voltage based on an output voltage of the output terminal close to a target value; and an external setting terminal which sets the feedback voltage to a prescribed potential regardless of voltage of the output terminal.

The semiconductor integrated circuit according to the present invention uses the same configuration as typical battery input, but when using an AC adaptor or other power supply apparatus as an input power supply, the semiconductor integrated circuit can accept output from the AC adaptor or the like as a first output voltage and can operate a second power supply circuit by deactivating a first power supply circuit.

### BRIEF DESCRIPTION OF THE DRAWINGS

FIG. 1 is a block diagram of a multi-output power supply apparatus configured with a semiconductor integrated circuit according to the present invention;

FIG. 2 is a block diagram of the multi-output power supply apparatus using a higher-voltage AC adaptor than in FIG. 1 as an input power supply;

FIG. 3A is a partial block diagram of a multi-output power supply apparatus according to a second embodiment of the present invention;

FIG. 3B is a partial block diagram of the multi-output power supply apparatus according to the second embodiment of the present invention using a high-voltage AC adaptor as an input power supply; and

FIG. 4 is a block diagram of a conventional multi-output power supply apparatus.

### DESCRIPTION OF THE EMBODIMENTS

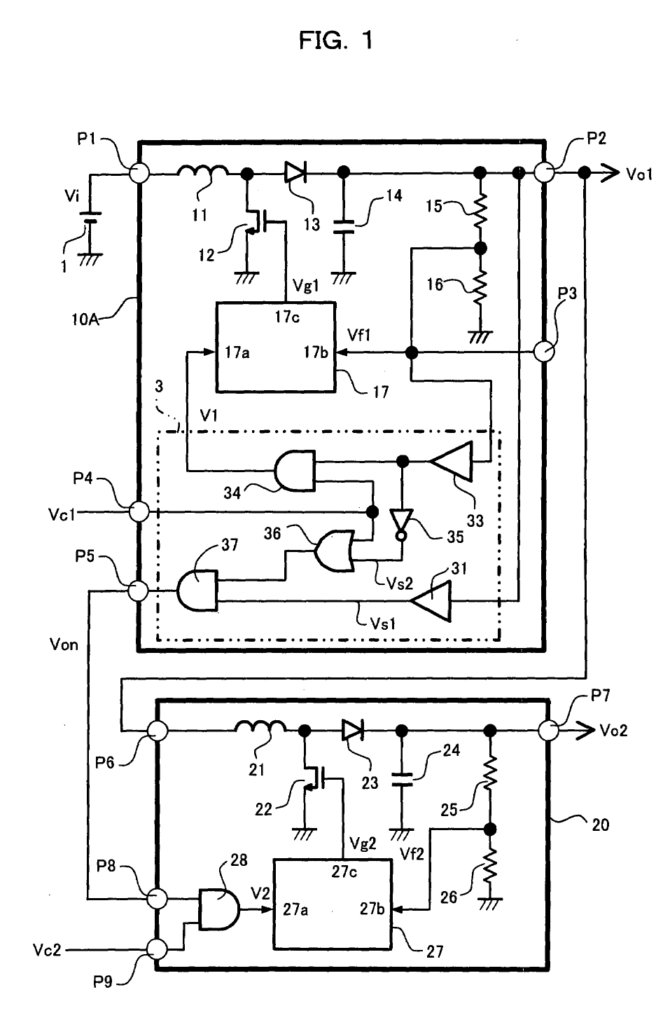

Embodiments of the present invention will be described below with reference to FIGS. 1, 2, 3A, and 3B.

### First Embodiment

FIG. 1 shows a multi-output power supply apparatus which uses a semiconductor integrated circuit according to the present invention.

The multi-output power supply apparatus includes a first power supply circuit 10A and a second power supply circuit 20. A first output voltage Vo1 of the first power supply circuit 10A is, for example, 5 V. A second output voltage Vo2 of the second power supply circuit 20 which uses the first output voltage Vo1 as an input power supply is, for example, 12 V.

In FIG. 1, for example, a single-cell lithium-ion battery 1 is mounted as an input power supply and an input voltage Vi is 2.5 to 4 V. The first power supply circuit 10A is made up of a semiconductor integrated circuit and includes a first external connection terminal P1 connected with the lithium-ion battery 1, a second external connection terminal P2 which produces the first output voltage Vo1, a third external connection terminal P3 which sets a type of input power supply to be used, a fourth external connection terminal P4 in which a first control signal Vc1 is inputted instructing the first power supply circuit 10A to start operation, and a fifth external connection terminal P5 which outputs a power-on signal Von to the second power supply circuit 20.

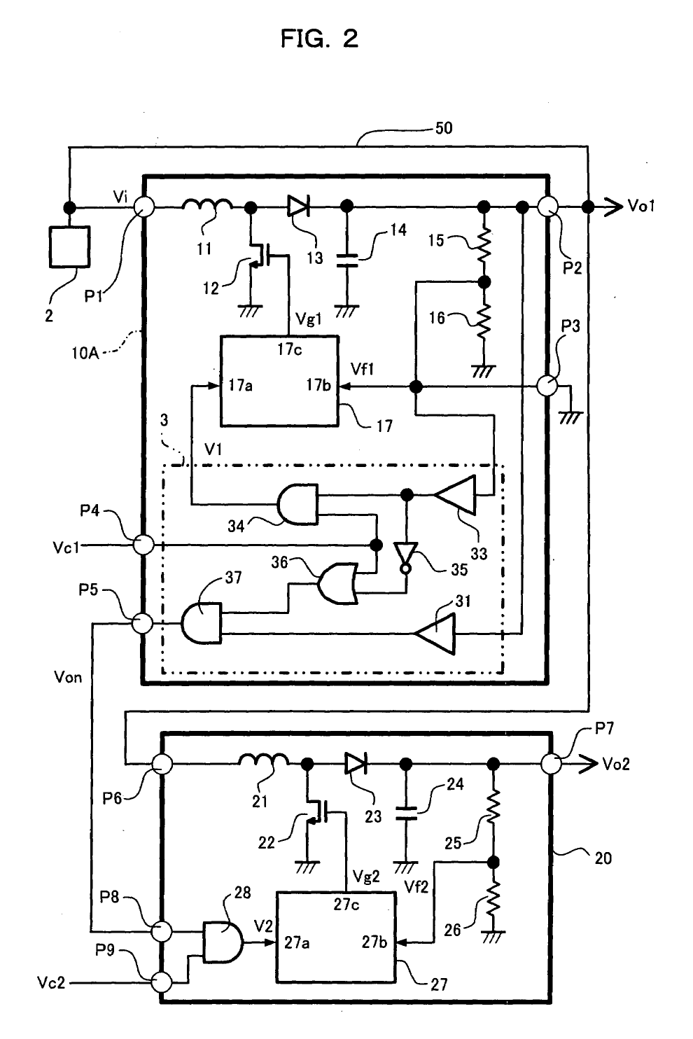

Incidentally, when using the first power supply circuit 10A and the second power supply circuit 20 described above to configure a multi-output power supply apparatus for electronic equipment on which an external power supply apparatus such as an AC adaptor is mounted as an input power supply and whose input voltage Vi is 4.5 to 5.5 V, it is possible to operate the second power supply circuit 20 while deactivating the first power supply circuit 10A by short-circuiting an input and output of the first power supply circuit 10A by an external connection 50 and grounding the third external connection terminal P3 as shown in FIG. 2.

FIG. 1 will be described in detail.

Reference numeral 1 denotes the lithium-ion battery which supplies the input voltage Vi, where Vi=2.5 to 4 V in the case of a single-cell lithium-ion battery. Reference numeral 10A denotes the first power supply circuit—specifically, a boost converter—which includes an inductor 11 and main switch 12 connected in series with each other and in parallel to the input power supply 1, a diode 13 connected to a junction point of the main switch 12 and inductor 11, an output capacitor 14 which, being connected to an output of the diode 13, outputs the first output voltage Vo1 (e.g., 5 V), a resistor 15 and resistor 16 which produce a fraction of the first output voltage Vo1 as a feedback voltage Vf1, and a first control circuit 17 which turns on and off the main switch 12. The first control circuit 17 has a control terminal 17a, feedback terminal 17b, and pulse output terminal 17c. It starts operation when a High signal is applied to the control terminal 17a. The first control circuit 17 outputs, from the pulse output terminal 17c, a pulse signal Vg1 whose on-off time ratio has been adjusted so that the feedback voltage Vf1 inputted in the feedback terminal 17b will be equal to a predetermined reference voltage Vr.

Reference numeral 3 denotes a power-on signal generating circuit that includes a comparison circuit 31 which outputs a High signal when the first output voltage Vo1 is equal to or larger than a predetermined output voltage value (e.g., 90% of a target voltage), a comparison circuit 33 serving as a second comparison circuit which outputs a High signal when the feedback voltage Vf1 of the first power supply circuit 10A is equal to or higher than a predetermined lower limit (e.g., 0.2 V), an AND circuit 34 which outputs a first signal V1 which is a logical product of a comparison circuit's (33) output and the first control signal Vc1, an inverter 35 which inverts the output of the comparison circuit 33, an OR circuit 36 which outputs a logical sum of an inverter's (35) output and the first control signal Vc1, and an AND circuit 37 which outputs a power-on signal which is a logical product of an output of the comparison circuit 31 and output of the OR circuit 36. Reference character Vs1 denotes a detection signal which indicates that the first output voltage is equal to or larger than the predetermined output voltage value and reference character Vs2 denotes a detection signal which indicates that the feedback voltage Vf1 is equal to or lower than a prescribed potential (0.2 V). The first signal V1 outputted from the AND circuit 34 is inputted in the control terminal 17a of the first control circuit 17.

Reference numeral 20 denotes the second power supply circuit—specifically, a boost converter—which includes a sixth external connection terminal P6 connected with an output of the first power supply circuit 10A, a seventh external connection terminal P7 which produces the second output voltage Vo2, an eighth external connection terminal P8 in which the power-on signal Von is inputted from the first power supply circuit 10A, and a ninth external connection terminal P9 in which a second control signal Vc2 is inputted instructing the second power supply circuit 20 to start operation.

More specifically, the second power supply circuit 20 includes an inductor 21 and main switch 22 connected in series with each other and in parallel to the output capacitor 14 of the first power supply circuit 10A, a diode 23 connected to a junction point of the main switch 22 and inductor 21, an output capacitor 24 which, being connected to an output of the diode 23, outputs a second output voltage Vo2 (e.g., 12 V), a resistor 25 and resistor 26 which produce a fraction of the second output voltage Vo2 as a feedback voltage Vf2, and a second control circuit 27 which turns on and off the main switch 22. The second control circuit 27 has a control terminal 27a, feedback terminal 27b, and pulse output terminal 27c. It starts operation when a High signal is applied to the control terminal 27a. The second control circuit 27 outputs, from the pulse output terminal 27c, a pulse signal Vg2 whose on-off time ratio has been adjusted so that the feedback voltage Vf2 inputted in the feedback terminal 27b will be equal to the predetermined reference voltage Vr. Reference numeral 28 denotes an AND circuit which outputs a logical product of the power-on signal Von and second control signal Vc2 to the control terminal 27a.

Operation of the first power supply circuit 10A of the multi-output power supply apparatus in FIG. 1 will be described.

If the input voltage Vi (2.5 to 4 V) is being applied, the first output voltage Vo1 is generated and a voltage fraction produced by the resistor 15 and resistor 16 is equal to or higher than a predetermined lower limit.

Thus, the output of the comparison circuit 33 is High. When the first control signal Vc1 goes High, the first signal V1 outputted by the AND circuit 34 goes High as well, causing the first control circuit 17 to start operating and output the pulse signal Vg1 from the pulse output terminal 17c. When the main switch 12 is turned on by the pulse signal Vg1, the inductor 11 to which the input voltage Vi is applied is energized, passing an increasing current. Next, when the main switch 12 is turned off, a decreasing current flows through the output capacitor 14 via the diode 13, causing the inductor 11 to release energy. Through repetition of the on/off operation, power is supplied from the input power supply 1 to the output capacitor 14 and the first output voltage Vo1 is outputted. The first output voltage Vo1 is controlled by an on-off time ratio of the main switch 12. Under ideal conditions in which forward voltage drops and the like of the diode 13 are ignored, if a proportion (referred to as a duty factor) of a conduction period in one switching cycle of the main switch 12 is δ1, the first output voltage Vo1 is given by:

Vo1=Vi/(1−δ1) (1)

As the first control circuit 17 adjusts the duty factor of the pulse signal Vg1 so that the feedback voltage Vf1 will be equal to the predetermined reference voltage Vr, the first output voltage Vo1 is stabilized at a target value. If resistance values of the resistors 15 and 16 are R15 and R16, respectively, the stabilized first output voltage Vo1 is given by:

Vo1=Vr·(1+R15/R16) (2)

Next, when the first output voltage Vo1 exceeds a predetermined voltage value, the comparison circuit 31 of the power-on signal generating circuit 3 outputs a High. On the other hand, the OR circuit 36, in which the first control signal Vc1 in a High state has been inputted, also outputs a High. The power-on signal Von—which is the logical product of the output of the OR circuit 36 and output of the comparison circuit 31—outputted from the AND circuit 37 is also High. Thus, when the second control signal Vc2 goes High, the second signal V2, which is the logical product of the second control signal Vc2 and power-on signal Von, also goes High. In the second power supply circuit 20, the second control circuit 27 starts operation when the second signal V2 in a High state is inputted in the control terminal 27a, and turns on and off the main switch 22 based on the pulse signal Vg2 from the pulse output terminal 27c. Subsequent operation of the second power supply circuit 20 is the same as the first power supply circuit 10A. Specifically, by turning on and off the main switch 22, the second power supply circuit 20 boosts the first output voltage Vo1 to the second output voltage Vo2 and stabilizes the second output voltage Vo2 at a target value.

As an input power supply, instead of using the single-cell lithium-ion battery 1 described above, some electronic equipment uses, for example, an AC adaptor which outputs 4.5 to 5.5 VDC or a step-down power supply apparatus which draws power from a two-cell lithium-ion battery and outputs 5 V. The multi-output power supply apparatus according to the present invention can be used as well for such electronic equipment and this will be described with reference to FIG. 2.

Configuration in FIG. 2 differs from configuration in FIG. 1 in that an external power supply apparatus 2 such as an AC adaptor is mounted as an input power supply instead of a battery and is also connected to the output capacitor 14 so as to be used as the first output voltage Vo1 as well, that the resistors 15 and 16 which detect the first output voltage Vo1 and provide feedback are omitted, and that the feedback terminal 17b of the first control circuit 17 and input to the comparison circuit 33 are grounded.

Operation of the multi-output power supply apparatus in FIG. 2 will be described, focusing on the power-on signal generating circuit 3.

Since the input to the comparison circuit 33, is grounded, the output from the comparison circuit 33 is Low. Consequently, the output of the AND circuit 34 goes Low as well and the first control circuit 17 stops operation with a Low inputted in the control terminal 17a. On the other hand, since the inverter 35 outputs a High, the OR circuit 36 outputs a High regardless of the first control signal Vc1 which no longer makes any sense. Also, the first output voltage V61 is high enough because of power supply from the external power supply apparatus 2, and consequently the output of the comparison circuit 31 is High as well. The power-on signal Von—which is the logical product of the output of the comparison circuit 31 and output of the OR circuit 36—outputted from the AND circuit 37 is also High. Thus, when the second control signal Vc2 goes High, the second signal V2, which is the logical product of the second control signal Vc2 and power-on signal Von, also goes High. In the second power supply circuit 20, the second control circuit 27 starts operation when the second signal V2 in a High state is inputted in the control terminal 27a.

Thus, whereas when operating the first power supply circuit 10A using a lithium-ion battery 1 as an input power supply, a fraction of the first output voltage Vo1 is applied to the feedback terminal 17b via the resistors 15 and 16; when an external power supply apparatus 2 such as an AC adaptor is used as an input power supply and output voltage of the external power supply apparatus 2 is applied directly to the feedback terminal 17b as the first output voltage Vo1, it is possible to operate the second power supply circuit 20 while deactivating the first power supply circuit 10A by grounding the feedback terminal 17b.

Although the first control circuit 17 and power-on signal generating circuit 3 are treated as separate blocks for convenience of illustration, if at least these two circuits are formed in the same semiconductor integrated circuit, configurations in FIGS. 1 and 2 differ only in processes of the feedback terminal 17b, apart from a connection method of the input power supply.

Out of the inductor 11, main switch 12, diode 13, and output capacitor 14 of the switching unit interposed between the first external connection terminal P1 and second external connection terminal P2, the inductor 11, for example, is installed outside the semiconductor circuit apparatus.

Although boost converters are used for both first power supply circuit 10A and second power supply circuit 20 described above, the present invention is not limited to such configuration. Since the present invention deactivates the first power supply circuit by grounding the feedback terminal of the first power supply circuit, if the first output voltage becomes zero on start-up such as when a step-down converter is used, it is recommended to provide a dead time for the comparison circuit 33 during start-up so that the voltage of the feedback terminal will be equal to or higher than a predetermined lower limit during the dead time i.e., the comparison circuit 33 will output a High. This makes it possible to use a voltage transformation circuit other than a boost converter.

### Second Embodiment

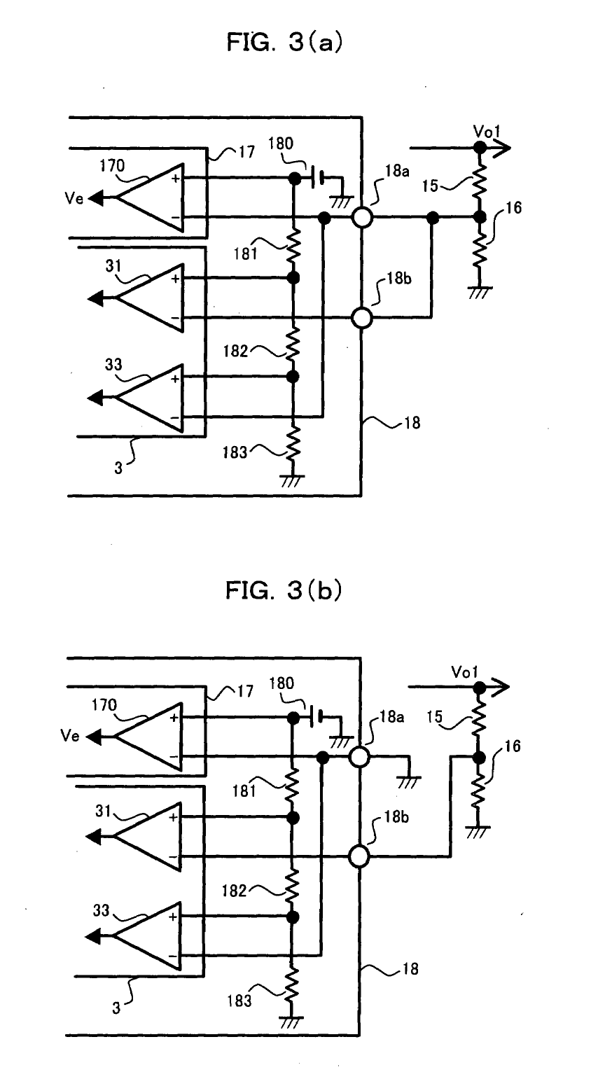

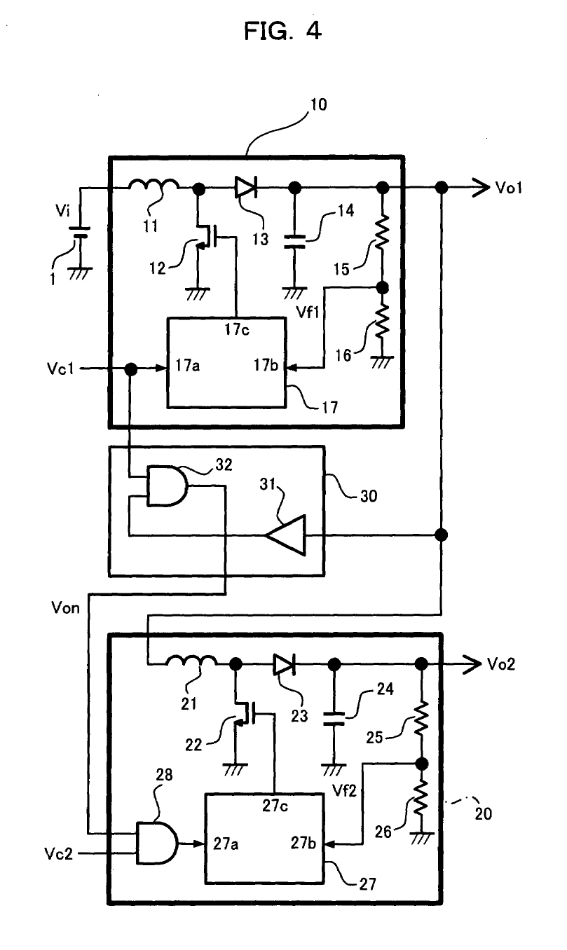

FIGS. 3A and 3B are partial circuit block diagrams of a multi-output power supply apparatus according to a second embodiment of the present invention.

In the first embodiment, the resistors 15 and 16 used to generate the feedback voltage Vf1 are installed separately at the input to the comparison circuit 33. This makes it necessary to install a separate detection resistor for the first output voltage Vo1 because the feedback terminal 17b is grounded when an external power supply apparatus is used as an input power supply.

Thus, in the second embodiment shown in FIG. 3A, the power-on signal generating circuit 3 and first control circuit 17 are integrated into a control unit 18, a feedback terminal 18a is installed by combining the input to the comparison circuit 33 and the feedback terminal 17b, and a terminal 18b is installed as the input to the comparison circuit 31. The rest of the configuration is the same as in FIGS. 1 and 2, and thus description thereof will be omitted. The feedback terminal 18a here corresponds to the third external connection terminal P3 according to the first embodiment.

FIG. 3A shows a circuit configuration of part and surroundings of the control unit 18 in a multi-output power supply apparatus for electronic equipment when, for example, a single-cell lithium-ion battery 1 is mounted as an input power supply and an input voltage Vi is 2.5 to 4 V. Reference numeral 180 denotes a reference voltage source which generates the reference voltage Vr. Reference numerals 181 to 183 denote resistors which produce a fraction of the reference voltage Vr. A junction point of resistors 181 and 182 is set, for example, to 90% of the reference voltage Vr and a junction point of resistors 182 and 183 is set to a predetermined lower limit (e.g., 0.2 V). Reference numeral 170 denotes an error amplifier included in the first control circuit 17. The error amplifier 170 compares the feedback voltage Vf1 of the feedback terminal 18a with the reference voltage Vr, thereby finds an error voltage, and outputs an error signal Ve obtained by amplifying the error voltage. Although not illustrated, the first control circuit 17 adjusts the duty factor of the pulse signal Vg1 according to the error signal Ve.

The comparison circuit 31 compares the feedback voltage Vf1 with 90% of the reference voltage Vr, and outputs a High if Vf1>0.9 Vr.

The comparison circuit 33 compares the feedback voltage Vf1 with a voltage value of 0.2 V, and outputs a High if Vf1>0.2 V.

FIG. 3B shows a multi-output power supply apparatus for electronic equipment when an external power supply apparatus such as an AC adaptor is mounted as an input power supply and an input voltage Vi is 4.5 to 5.5 V. The same configuration as in FIG. 3A is used for the control unit 18 so that the semiconductor integrated circuit including at least the control unit 18 can also be used when a predetermined voltage is inputted. Configuration in FIG. 3B differs from configuration in FIG. 3A only in that the feedback terminal 18a is grounded. When the feedback terminal 18a is grounded, a non-inverting input terminal of the comparison circuit 33 is grounded and becomes lower than 0.2 V, causing the comparison circuit 33 to output a Low. Consequently, the first control circuit 17 stops operation and the power-on signal Von goes High. The second signal V2 becomes equal to the second control signal Vc2, enabling the second power supply circuit 20 to operate.

With this configuration, when a battery is mounted supplying a low-voltage input, a voltage applied to the feedback terminal 18a and a voltage applied to the input terminal 18b of the comparison circuit 31 can be shared with a voltage at a junction point of the resistors 15 and 16. Also, when an external power supply apparatus is mounted, the feedback terminal 18a can be grounded and the voltage at the junction point of the resistors 15 and 16 can be applied to the terminal 18b. That is, there is no need to install a detection resistor separately in order to compare the first output voltage Vo1 with a predetermined output voltage value.

Incidentally, although not mentioned in the description of the first and second embodiments, it is assumed that the first control circuit 17 and second control circuit 27 operate on the input voltage Vi or first output voltage Vo1.

The present invention is useful for a multi-output power supply apparatus which supplies DC voltages to various types of electronic equipment.

What is claimed is:

1. A semiconductor integrated circuit which converts an input supply voltage applied to an input terminal into a first output voltage and outputs the first output voltage from an output terminal, comprising:
a first control circuit which supplies a switching unit interposed between said input terminal and said output terminal with a switching signal so as to bring a feedback voltage based on an output voltage of said output terminal close to a target value; and an external setting terminal which sets said feedback voltage to a prescribed potential regardless of voltage of said output terminal.

2. A multi-output power supply apparatus comprising:
a first power supply circuit made up of a semiconductor integrated circuit which converts an input supply voltage applied to an input terminal into a first output voltage and outputs the first output voltage from a first output terminal; and
a second power supply circuit which converts the first output voltage outputted from the first output terminal of said first power supply circuit into a second output voltage and outputs the second output voltage from a second output terminal,
wherein said first power supply circuit includes a first control circuit which supplies a switching unit interposed between said input terminal and said first output terminal with a switching signal so as to bring a feedback voltage based on an output voltage of said first output terminal close to a target value, an external setting terminal which sets said feedback voltage to a prescribed potential regardless of voltage of said first output terminal, and a power-on signal generating circuit which generates a power-on signal using a logical product of a detection signal which indicates that said first output voltage is equal to or higher than a predetermined output voltage value and a detection signal which indicates that said feedback voltage is equal to or lower than a prescribed potential;
said second power supply circuit operates in response to the power-on signal generated from said first power supply circuit; and
said first control circuit of said first power supply circuit stops supplying said switching signal when said external setting terminal is set to a lower potential limit.

3. The multi-output power supply apparatus according to claim 2, wherein the power-on signal generating circuit comprises:
a first comparison circuit which detects that said feedback voltage is equal to or higher than the predetermined output voltage value,
a second comparison circuit which detects that said feedback voltage is equal to or lower than the prescribed potential, and
an AND circuit which generates said power-on signal using a logical product of a detection signal on an output side of said first comparison circuit and a detection signal on an output side of said second comparison circuit.

4. The multi-output power supply apparatus according to claim 2, wherein said second power supply circuit includes a second control circuit which supplies a second switching unit interposed between the first output terminal and the second output terminal with a switching signal so as to bring a feedback voltage based on an output voltage of said second output terminal close to a target value; and said second power supply circuit controls supply of said power-on signal from said power-on signal generating circuit to said second control circuit based on a result of a logical operation with a second control signal which externally instructs said second power supply circuit to start or stop operation.

5. The multi-output power supply apparatus according to claim 2, wherein said power-on signal generating circuit is equipped with a first comparison circuit which compares said first output voltage or a fraction of said first output voltage with a fraction of said predetermined reference voltage and thereby determines whether said first output voltage is equal to or higher than said predetermined output voltage value.

6. The multi-output power supply apparatus according to claim 2, wherein said power-on signal generating circuit is equipped with a second comparison circuit which compares a voltage of said feedback with a predetermined lower limit and produces an output so that the voltage of said feedback will be equal to or higher than said predetermined lower limit during a predetermined period of start-up upon application of input voltage or upon input of a first control signal.

7. A semiconductor integrated circuit used for a multi-output power supply apparatus that includes a first power supply circuit which converts an input supply voltage applied to an input terminal into a first output voltage and outputs the first output voltage from an output terminal, and a second power supply circuit which converts the first output voltage outputted from a first output terminal of said first power supply circuit into a second output voltage and outputs the second output voltage from a second output terminal, the semiconductor integrated circuit comprising:
a first control circuit which supplies a switching unit interposed between said input terminal and said output terminal with a switching signal so as to bring a feedback voltage based on an output voltage of said output terminal close to a target value; and an external setting terminal which sets said feedback voltage to a prescribed potential regardless of voltage of said output terminal.
